(19) United States
(12) Patent Application Publication
(10) Pub. No.: US 2025/0192293 A1
(43) Pub. Date: Jun. 12, 2025

(54) CYLINDRICAL BATTERY

(71) Applicant: Panasonic Energy Co., Ltd., Osaka (JP)

(72) Inventor: Shota YATOMI, Tokushima (JP)

(21) Appl. No.: 18/845,327

(22) PCT Filed: Mar. 2, 2023
(86) PCT No.: PCT/JP2023/007784

§ 371 Date: Sep. 9, 2024

(30) Foreign Application Priority Data
Mar. 17, 2022 (JP) 2022-042489

(51) Int. Cl. H01M 50/184; H01M 50/107; H01M 50/152; H01M 50/186; H01M 50/588

(52) U.S. Cl. CPC H01M 50/184; H01M 50/107; H01M 50/152; H01M 50/186; H01M 50/588

(57) ABSTRACT

A cylindrical battery comprises: an electrode body in which a positive electrode and a negative electrode are wound with a separator therebetween; a bottomed cylindrical external can in which the electrode body is housed; a sealing body that seals the opening of the external can; and a gasket that insulates the external can and the sealing body. The sealing body has, on the outer circumferential surface thereof, at least one recessed portion that opens outward in the radial direction. The gasket has at least one projecting portion that projects inward in the radial direction and fits in the at least one recessed portion.

### TECHNICAL FIELD

The present disclosure relates to a cylindrical battery.

### BACKGROUND

In recent years, applications of cylindrical batteries have been continuously expanding, and have been widely used, for example, ranging from applications to vehicles such as hybrid vehicles (HV) and electric vehicles (EV) to applications to information terminals such as notebook computers, smartphones, and tablets, as well as applications to electric tools and assisted bicycles. The cylindrical batteries are required to have high reliability, for example, highly reliable insulation between positive and negative electrodes and highly reliable performance in preventing a liquid leakage of an electrolytic solution.

In the related art, conventionally, there is a cylindrical battery described in Patent Literature 1. This cylindrical battery includes an external can, an electrode assembly housed in the external can, and a sealing assembly closing an opening of the external can. The sealing assembly is fixed to the opening of the external can in a caulking manner with a gasket interposed therebetween. The external can has a shoulder portion, a grooved portion, a cylindrical portion, and a bottom portion. The grooved portion is formed by recessing a partial portion of a side surface of the external can inward in a radial direction in an annular shape. The sealing assembly receives a force on the opening side in an axial direction through the gasket from an annular protrusion protruding inward in the radial direction due to the formation of the grooved portion. The shoulder portion is formed by bending an upper end portion of the external can inward toward a peripheral edge of the sealing assembly when the sealing assembly is fixed to the external can in a caulking manner. This cylindrical battery secures the sealing property by the caulking fixation.

### CITATION LIST

### Patent Literature

Patent Literature 1: JP 2000-48825 A

### SUMMARY

If an unexpected excessive external force is applied to a cylindrical battery due to a fall of the cylindrical battery or the like and a gasket is damaged, positive and negative electrodes may be short-circuited. In addition, in a case where the cylindrical battery is to be used for a long-term period, for example, to be used for power storage, it is preferable to suppress a liquid leakage caused when an electrolytic solution crawls up. Therefore, an object of the present disclosure is to provide a cylindrical battery capable of suppressing a short circuit between positive and negative electrodes even when an excessive external force is applied thereto, and suppressing a liquid leakage caused when an electrolytic solution crawls up.

In order to solve the aforementioned problems, a cylindrical battery according to the present disclosure includes: an electrode assembly in which a positive electrode and a negative electrode are wound with a separator interposed therebetween; a bottomed cylindrical external can that houses the electrode assembly; a sealing assembly that seals an opening of the external can; and a gasket that insulates the external can and the sealing assembly from each other, in which the sealing assembly has at least one recess that is open outward in a radial direction on an outer circumferential surface thereof, and the gasket has at least one protrusion protruding inward in the radial direction and fitted into the at least one recess.

The cylindrical battery according to the present disclosure is capable of suppressing a short circuit between the positive and negative electrodes even when an excessive external force is applied thereto, and suppressing a liquid leakage caused when an electrolytic solution crawls up.

### BRIEF DESCRIPTION OF DRAWINGS

FIG. 1 is an axial cross-sectional view of a cylindrical battery according to an embodiment of the present disclosure.

FIG. 2 is a perspective view of an electrode assembly of the cylindrical battery.

FIG. 3 is an enlarged cross-sectional view of the periphery around a sealing assembly of the cylindrical battery.

FIG. 4 is an enlarged schematic cross-sectional view of an upper end portion in an axial direction of the cylindrical battery.

FIG. 5 is an enlarged schematic cross-sectional view of a cylindrical battery according to a first modification corresponding to FIG. 4.

FIG. 6 is an enlarged schematic cross-sectional view of a cylindrical battery according to a second modification corresponding to FIG. 4.

FIG. 7 is an enlarged schematic cross-sectional view of a cylindrical battery according to a third modification corresponding to FIG. 4.

FIG. 8 is an enlarged schematic cross-sectional view of a shoulder portion on one side of the cylindrical battery according to the present disclosure.

### DESCRIPTION OF EMBODIMENTS

Hereinafter, an embodiment of a cylindrical battery according to the present disclosure will be described in detail with reference to the drawings. The cylindrical battery according to the present disclosure may be a primary battery or a secondary battery. In addition, the cylindrical battery according to the present disclosure may be a battery using an aqueous electrolyte or a battery using a non-aqueous electrolyte. Hereinafter, a non-aqueous electrolyte secondary battery (lithium ion battery) using a non-aqueous electrolyte will be exemplified as a cylindrical battery 10 according to an embodiment, but the cylindrical battery according to the present disclosure is not limited thereto.

In a case where the following description includes a plurality of embodiments, modifications, and the like, it is assumed from the outset to construct a new embodiment by appropriately combining their characteristic parts. In the following embodiments, the same components are denoted by the same reference numerals in the drawings, and redundant description will be omitted. In addition, a plurality of drawings include schematic views, and dimensional ratios such as lengths, widths, and heights between different drawings for each member are not necessarily the same. In the present specification, for convenience of explanation, the sealing assembly 17 side in the axial direction (height direction) of the battery case 15 is referred to as “upper”, and the bottom side of the external can 16 in the axial direction is referred to as “lower”. Among components to be described below, components that are not recited in an independent claim indicating the highest concept are arbitrary components, and are not essential components.

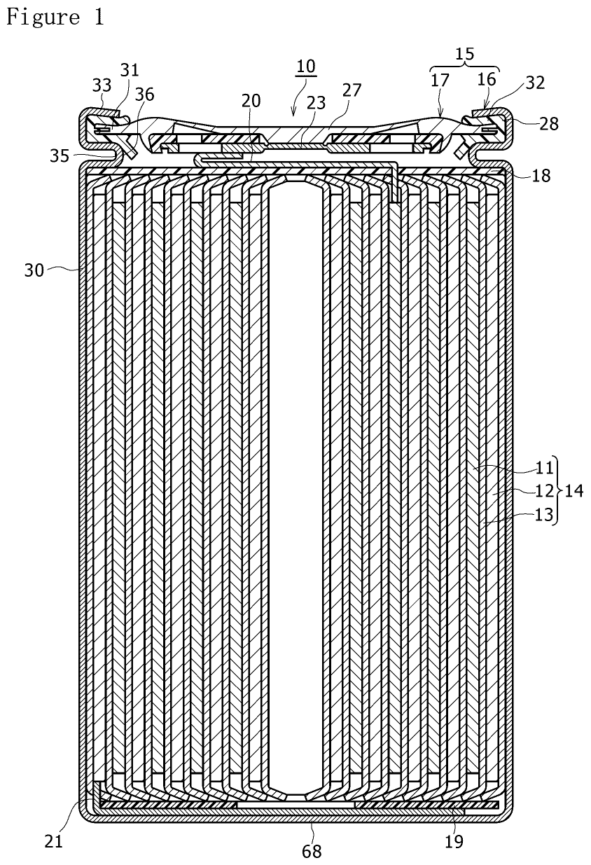

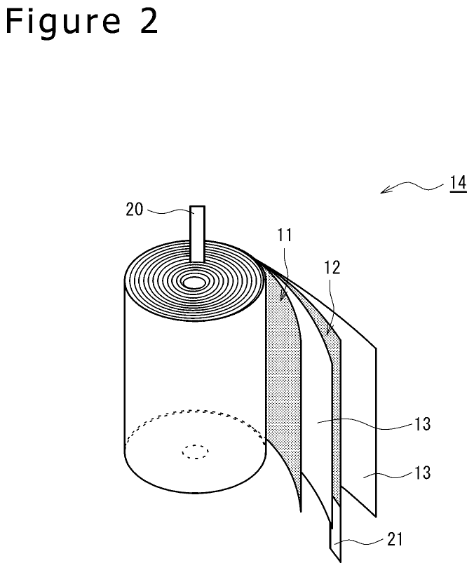

FIG. 1 is an axial cross-sectional view of a cylindrical battery 10 according to an embodiment of the present disclosure, and FIG. 2 is a perspective view of an electrode assembly 14 of the cylindrical battery 10. As illustrated in FIG. 1, cylindrical battery 10 includes a wound-type electrode assembly 14, a non-aqueous electrolyte (not illustrated), and a battery case 15 that houses the electrode assembly 14 and the non-aqueous electrolyte. The battery case 15 includes a bottomed cylindrical external can 16 and a sealing assembly 17 that closes an opening of the external can 16. Further, the cylindrical battery 10 includes a resin gasket 28 disposed between the external can 16 and the sealing assembly 17.

The non-aqueous electrolyte includes a non-aqueous solvent and an electrolyte salt dissolved in the non-aqueous solvent. As the non-aqueous solvent, for example, esters, ethers, nitriles, amides, and mixed solvents of two or more thereof may be used. The non-aqueous solvent may contain a halogen-substituted product in which at least some of hydrogen in any of the solvents described above is substituted with a halogen atom such as fluorine. It should be noted that the non-aqueous electrolyte is not limited to the liquid electrolyte, and may be a solid electrolyte using a gel polymer or the like. As the electrolyte salt, a lithium salt such as LiPF₆ is used.

As illustrated in FIG. 2, the electrode assembly 14 has an elongated positive electrode 11, an elongated negative electrode 12, and two elongated separators 13, and has a wound structure in which the positive electrode 11 and the negative electrode 12 are wound with the separator 13 interposed therebetween. A positive electrode lead 20 is joined to the positive electrode 11 of the electrode assembly 14, and a negative electrode lead 21 is joined to the negative electrode 12 of the electrode assembly 14. The negative electrode 12 is formed to have a larger size than the positive electrode 11 in order to suppress precipitation of lithium, and is formed to be longer than the positive electrode 11 in a longitudinal direction and a width direction (a lateral direction). Further, the two separators 13 are formed to have a larger size than at least the positive electrode 11, and are disposed, for example, so as to sandwich the positive electrode 11.

The positive electrode 11 includes a positive electrode current collector and positive electrode mixture layers formed on both surfaces of the current collector. As the positive electrode current collector, a foil of a metal that is stable in a potential range of the positive electrode 11, such as aluminum or an aluminum alloy, a film in which the metal is disposed on its surface layer, or the like can be used. The positive electrode mixture layer contains a positive electrode active material, a conductive agent, and a binder. The positive electrode 11 can be produced by, for example, applying a positive electrode mixture slurry including a positive electrode active material, a conductive agent, a binder, etc. onto the positive electrode current collector, drying the coating film, and then compressing the film to form a positive electrode mixture layer on both surfaces of the positive electrode current collector.

The positive electrode active material is mainly composed of a lithium-containing metal composite oxide. Examples of the metal element included in the lithium-containing metal composite oxide include Ni, Co, Mn, Al, B, Mg, Ti, V, Cr, Fe, Cu, Zn, Ga, Sr, Zr, Nb, In, Sn, Ta, and W. An example of a preferred lithium-containing metal composite oxide is a composite oxide containing at least one of Ni, Co, Mn, and Al.

Examples of the conductive agent included in the positive electrode mixture layer include carbon materials such as carbon black, acetylene black, Ketjenblack, and graphite. Examples of the binder included in the positive electrode mixture layer include fluororesins such as polytetrafluoroethylene (PTFE) and polyvinylidene fluoride (PVdF), polyacrylonitrile (PAN), polyimide, acrylic resins, and polyolefin. These resins may be used in combination with a cellulose derivative such as carboxymethyl cellulose (CMC) or its salt, polyethylene oxide (PEO), or the like.

The negative electrode 12 includes a negative electrode current collector and negative electrode mixture layers formed on both surfaces of the current collector. As the negative electrode current collector, for example, a foil of a metal that is stable in a potential range of the negative electrode 12, such as copper or a copper alloy, a film in which the metal is disposed on its surface layer, or the like can be used. The negative electrode mixture layer contains a negative electrode active material and a binder. The negative electrode 12 can be produced by, for example, applying a negative electrode mixture slurry including a negative electrode active material, a binder, etc. onto the negative electrode current collector, drying the coating film, and then compressing the film to form a negative electrode mixture layer on both surfaces of the negative electrode current collector.

As the negative electrode active material, a carbon material that reversibly absorbs and releases lithium ions is generally used. A preferred carbon material is graphite such as natural graphite such as flake graphite, massive graphite, or amorphous graphite, or artificial graphite such as massive artificial graphite or graphitized mesophase-carbon microbead. The negative electrode mixture layer may contain a Si-containing compound as the negative electrode active material. As the negative electrode active material, a metal to be alloyed with lithium other than Si, an alloy containing the metal, a compound containing the metal, or the like may be used.

As the binder included in the negative electrode mixture layer, a fluororesin, PAN, a polyimide resin, an acrylic resin, a polyolefin resin, or the like may be used as is the case with the positive electrode 11, but styrene-butadiene rubber (SBR) or a modified product thereof is preferably used. The negative electrode mixture layer may contain, for example, CMC or a salt thereof, polyacrylic acid (PAA) or a salt thereof, polyvinyl alcohol or the like in addition to SBR or the like.

As the separator 13, a porous sheet having ion permeability and insulation is used. Specific examples of the porous sheet include a fine porous thin film, a woven fabric, and a non-woven fabric. As a material of the separator 13, an olefin-based resin such as polyethylene or polypropylene, cellulose, or the like is preferable. The separator 13 may have a single-layered structure or a multi-layered structure. A heat-resistant layer or the like may be formed on a surface of the separator 13. The negative electrode 12 may constitute a winding start end of the electrode assembly 14, but it is general that the separator 13 extends beyond a winding start-side end of the negative electrode 12, such that the winding start end of the electrode assembly 14 is a winding start-side end of the separator 13.

In the example illustrated in FIGS. 1 and 2, the positive electrode lead 20 is electrically connected to an intermediate portion such as a central portion in the winding direction of the positive electrode current collector, and the negative electrode lead 21 is electrically connected to a winding-finish end in the winding direction of the negative electrode current collector. However, the negative electrode lead may be electrically connected to a winding-start end of the negative electrode current collector in the winding direction. Alternatively, the electrode assembly may have two negative electrode leads, one of the negative electrode leads may be electrically connected to the winding-start end in the winding direction of the negative electrode current collector, and the other negative electrode lead may be electrically connected to the winding-finish end in the winding direction of the negative electrode current collector. Alternatively, the negative electrode and the external can may be electrically connected by bringing the winding finish-side end in the winding direction of the negative electrode current collector into contact with an inner surface of the external can. Alternatively, the negative electrode lead may be electrically connected to the winding start-side end in the winding direction of the negative electrode current collector, and the winding finish-side end in the winding direction of the negative electrode current collector may be brought into contact with the inner surface of the external can.

As illustrated in FIG. 1, cylindrical battery 10 further includes an upper insulating plate 18 disposed on an upper side of the electrode assembly 14 and a lower insulating plate 19 disposed on a lower side of the electrode assembly 14. In the example illustrated in FIG. 1, the positive electrode lead 20 attached to the positive electrode 11 extends toward the sealing assembly 17 through a through hole of the upper insulating plate 18, and the negative electrode lead 21 attached to the negative electrode 12 extends toward a bottom plate portion 68 of the external can 16 through an outer side of the lower insulating plate 19. The positive electrode lead 20 is connected to a lower surface of a terminal plate 23, which is a bottom plate of the sealing assembly 17, by welding or the like, and a vent member (a rupture disk) 27, which is a top plate of the sealing assembly 17 electrically connected to the terminal plate 23, serves as a positive electrode terminal. In addition, the negative electrode lead 21 is connected to the inner surface of the bottom plate portion 68 of the external can 16 by welding or the like, and the external can 16 serves as a negative electrode terminal.

The external can 16 is a metal container having a bottomed cylindrical portion. A gap between the external can 16 and the sealing assembly 17 is sealed with an annular gasket 28, which seals an internal space of the battery case 15. The gasket 28 includes a sandwiched portion 32 sandwiched between the external can 16 and the sealing assembly 17 to insulate the sealing assembly 17 from the external can 16. That is, the gasket 28 serves as a sealing material for maintaining airtightness inside the battery, and serves to prevent a leakage of an electrolytic solution. The gasket 28 also serves as an insulating material that prevents a short circuit between the external can 16 and the sealing assembly 17.

The external can 16 has a protrusion 36 protruding inward in the radial direction on an inner circumferential side by providing an annular groove 35 in a partial portion of a cylindrical outer circumferential surface of the external can 16 in the axial direction. The annular groove 35 can be formed, for example, by spinning a partial portion of the cylindrical outer circumferential surface inward in the radial direction to be recessed inward in the radial direction. The external can 16 has an annular shoulder portion 33 together with the bottomed cylindrical portion 30 including the protrusion 36. The bottomed cylindrical portion 30 houses the electrode assembly 14 and the non-aqueous electrolyte, and the shoulder portion 33 is bent inward in the radial direction from an end of the bottomed cylindrical portion 30 on the opening side and extends inward. The shoulder portion 33 is formed when an upper end portion of the external can 16 is bent inward to caulk a peripheral edge 31 of the sealing assembly 17. The sealing assembly 17 is sandwiched between the shoulder portion 33 and the upper side of the protrusion 36 together with the gasket 28, and is fixed to the external can 16 by caulking.

Next, the sealing assembly 17 will be described in detail. FIG. 3 is an enlarged cross-sectional view of the periphery around the sealing assembly of the cylindrical battery 10. As illustrated in FIG. 3, the sealing assembly 17 has a structure in which the terminal plate 23, the annular insulating plate 25, and the vent member 27 are stacked in this order from the electrode assembly 14 side. The vent member 27 has a circular shape in plan view. The vent member 27 can be manufactured by, for example, pressing a plate material of aluminum or an aluminum alloy. Since the aluminum and the aluminum alloy are excellent in flexibility, they are preferable for use as a material of the vent member 27.

The vent member 27 has a thin portion 27c formed in an intermediate portion connecting a central portion 27a and an outer circumferential portion 27b thereof. When the internal pressure of the battery rises, the thin portion 27c is inverted and broken, so that the vent member 27 functions as an explosion-proof valve. The central portion 27a is formed so as to protrude toward the terminal plate 23, thereby facilitating connection between the vent member 27 and the terminal plate 23.

The insulating plate 25 is formed in an annular shape in plan view and has a through hole 25a at the center. The insulating plate 25 is fitted and fixed to an annular protrusion 27d formed so as to protrude downward in the outer circumferential portion 27b of the vent member 27. The insulating plate 25 is provided to ensure insulation. The insulating plate 25 is preferably made of a material that does not affect battery characteristics. Examples of the material of the insulating plate 25 include a polymer resin, such as a polypropylene (PP) resin and a polybutylene terephthalate (PBT) resin. The insulating plate 25 has a ventilation hole 25b that penetrates therethrough in the axial direction on an outer circumferential side thereof. Further, the insulating plate 25 has an annular skirt 25c extending downward at an outer peripheral edge thereof.

The terminal plate 23 has a circular outer shape having a smaller diameter than the insulating plate 25 in plan view, with a central portion 23a thereof being a thin portion. The terminal plate 23 is disposed to face the vent member 27 with the insulating plate 25 interposed therebetween. The terminal plate 23 is attached to the insulating plate 25 by internally fitting and fixing its outer circumferential surface to an inner circumferential surface of the skirt 25c of the insulating plate 25. The center portions of the vent member 27 and the terminal plate 23 are connected to each other via the through hole 25a of the insulating plate 25.

Similarly to the vent member 27, the terminal plate 23 is preferably formed of aluminum or an aluminum alloy. By doing so, it is possible to easily connect the central portions of the vent member 27 and the terminal plate 23 to each other. As a connection method, metallurgical joining is preferably used, and laser welding is exemplified as the metallurgical joining. A ventilation hole 23b penetrating the terminal plate 23 in the axial direction is formed on the outer circumferential side of the terminal plate 23. The ventilation hole 23b communicates with the ventilation hole 25b of the insulating plate 25. As illustrated in FIG. 3, the inner circumferential surface of the skirt 25c may have a truncated cone shape in which the inner diameter decreases downward, and the outer circumferential surface of the terminal plate 23 may have a truncated cone shape corresponding to the inner circumferential surface of the skirt 25c. In such a case, by press-fitting and fixing the terminal plate 23 to the skirt 25c, a positional deviation of the terminal plate 23 with respect to the vent member 27 can be reliably prevented.

The gasket 28 is tightly fixed to the sealing assembly 17 with a fixing structure to be described below. The sealing assembly 17 has an annular recess 52 that is open outward in the radial direction on an outer circumferential surface thereof, and in the present embodiment, the annular recess 52 is provided on an outer circumferential surface of the vent member 27. The gasket 28 has an annular protrusion 53 protruding inward in the radial direction, and the annular protrusion 53 is fitted into the annular recess 52. As a result, the gasket 28 is tightly fixed to the vent member 27 in a firm manner.

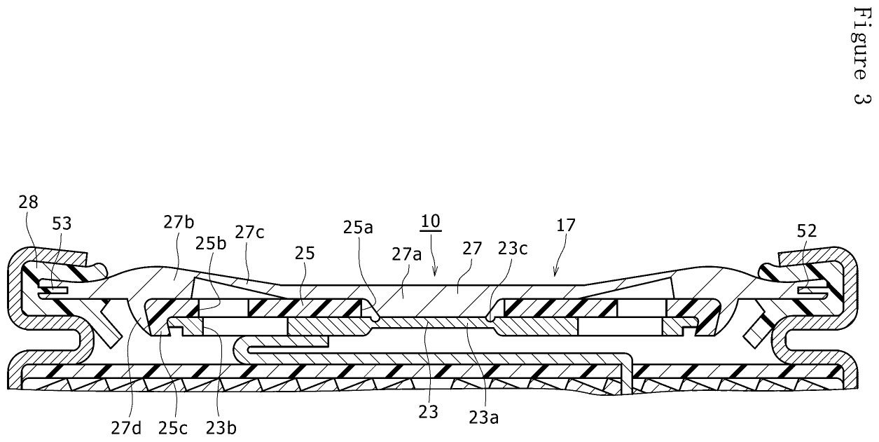

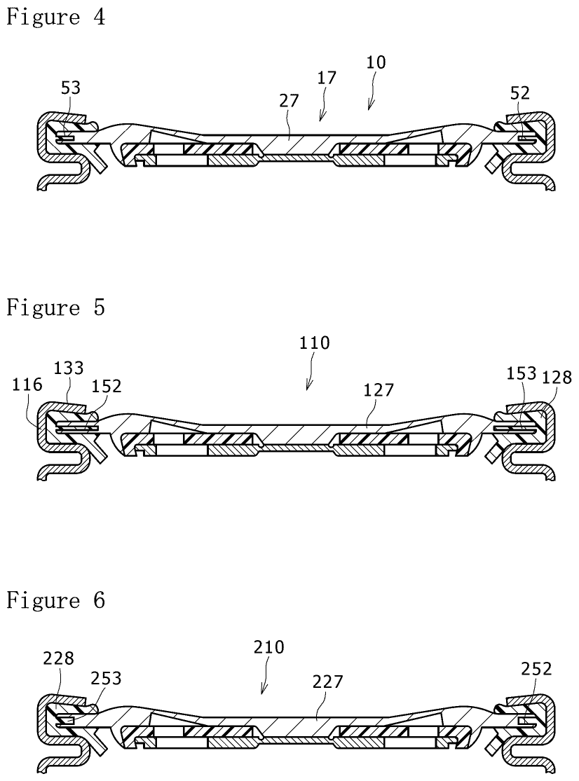

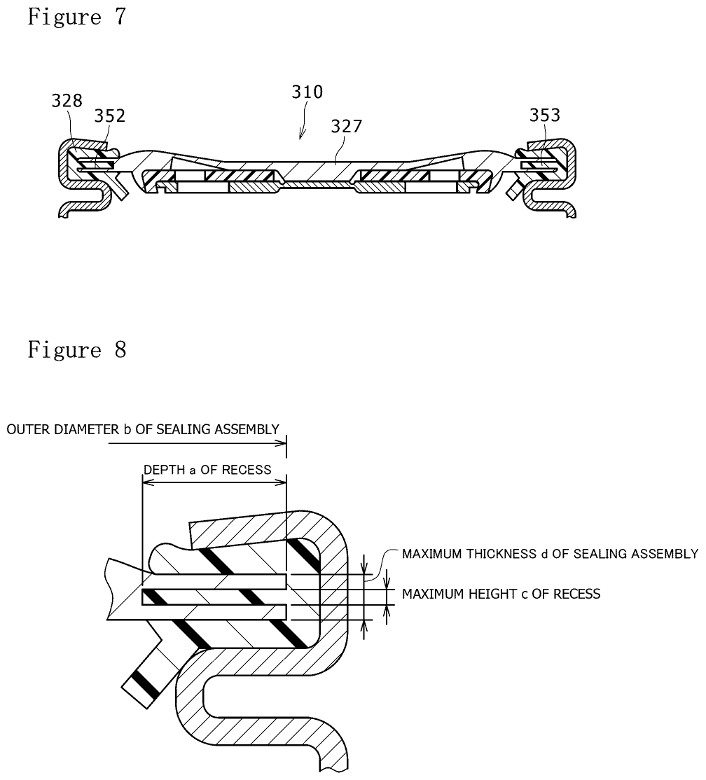

FIG. 4 is an enlarged schematic cross-sectional view of an upper end portion in the axial direction of the cylindrical battery 10, and FIG. 5 is an enlarged schematic cross-sectional view of a cylindrical battery 110 according to a first modification corresponding to FIG. 4. FIG. 6 is an enlarged schematic cross-sectional view of a cylindrical battery 210 according to a second modification corresponding to FIG. 4, and FIG. 7 is an enlarged schematic cross-sectional view of a cylindrical battery 310 according to a third modification corresponding to FIG. 4. As illustrated in FIGS. 4 and 5, an annular recess 152 provided on an outer circumferential surface of a vent member 127 may have a larger depth than the annular recess 52 provided in the vent member 27 of the cylindrical battery 10, and the bottom of the annular recess 52 may be located radially inward of a shoulder portion 133 of an external can 116. Also, an annular protrusion 153 of a gasket 128 fitted into the annular recess 152 may have a larger radial length than the annular protrusion 53 of the gasket 28 of the cylindrical battery 10.

As illustrated in FIGS. 4 and 6, an annular recess 252 provided on an outer circumferential surface of a vent member 227 may have a larger maximum axial height than the annular recess 52 provided in the vent member 27 of the cylindrical battery 10, and an annular protrusion 253 of a gasket 228 fitted into the annular recess 252 may have a block shape. Then, the annular protrusion 253 may have a larger maximum axial thickness than the annular protrusion 53 of the gasket 28 fitted into the annular recess 52 of the cylindrical battery 10. Alternatively, as illustrated in FIGS. 4, 5, and 7, an annular recess 352 provided on an outer circumferential surface of a vent member 327 may have a larger depth than the annular recess 52 of the cylindrical battery 10, and may have a smaller depth than the annular recess 152 of the cylindrical battery 110 according to the first modification. Also, an annular protrusion 353 of a gasket 328 fitted into the annular recess 352 may have a larger radial length than the annular protrusion 53 of the gasket 28 of the cylindrical battery 10, or may have a smaller radial length than the annular protrusion 153 of the gasket 128 of the cylindrical battery 110 according to the first modification.

Alternatively, as illustrated in FIGS. 4, 6, and 7, the annular recess 352 provided on the outer circumferential surface of the vent member 327 may have a larger maximum axial height than the annular recess 52 provided in the vent member 27 of the cylindrical battery 10, or may have a smaller maximum axial height than the annular recess 252 provided in the vent member 227 of the cylindrical battery 210 according to the second modification. Also, the annular protrusion 353 of the gasket 328 fitted into the annular recess 352 may have a larger maximum axial thickness than the annular protrusion 53 of the gasket 28 fitted into the annular recess 52 of the cylindrical battery 10, or may have a smaller maximum axial thickness than the annular protrusion 253 of the gasket 228 fitted into the annular recess 252 of the cylindrical battery 210 according to the second modification.

More specifically, referring to FIG. 8, that is, an enlarged schematic cross-sectional view of a shoulder portion on one side of a cylindrical battery according to the present disclosure, assuming that a depth of an annular recess of a sealing assembly (corresponding to an annular recess of a vent member in the example illustrated in FIG. 8) is a [cm], and an outer diameter of the sealing assembly is b [cm], a≤0.1×b is preferable because the sufficient strength of the sealing assembly can be secured, and the excessive deformation of the sealing assembly can be suppressed at the time of caulking. In addition, a ≥0.02×b is preferable, damage to the gasket when an external force is applied can be effectively suppressed.

Referring to FIG. 8, assuming that a maximum height of the annular recess of the sealing assembly is c [cm], and a maximum thickness in a sandwiched portion of the sealing assembly that is sandwiched in the axial direction by the gasket is d [cm], when c≥0.1×d, the annular protrusion of the gasket can be smoothly inserted into the annular recess. In this case, the gasket can also be made sufficiently thick, which is preferable because the breakage of the gasket caused by the physical deformation of the caulked portion when an external force is applied can be effectively suppressed. In addition, c≤0.2×d is preferable, because the sufficient strength of the sealing assembly can be secured, and the excessive deformation of the sealing assembly can be suppressed at the time of caulking.

### Example 1

### (Production of Positive Electrode)

Li(Ni_{0.8}Co_{0.15}Al_{0.05})O₂ was used as a positive electrode active material. A positive electrode mixture paste was prepared by mixing 100 parts by mass of the positive electrode active material, 2.0 parts by mass of polyvinylidene fluoride as a binder, and 2.0 parts by mass of acetylene black as a conductive agent in a liquid component (NMP). The positive electrode mixture paste was applied to both surfaces of a positive electrode current collector made of an aluminum foil except for a positive electrode lead-connected portion, and dried to form a positive electrode mixture layer. The prepared positive electrode precursor was compressed to obtain a positive electrode. The positive electrode lead-connected portion was formed at a central portion of the positive electrode.

### (Production of Negative Electrode)

Graphite was used as a negative electrode active material. A negative electrode paste was obtained by mixing 100 parts by mass of the negative electrode active material, 1.0 parts by mass of polyvinylidene fluoride as a binder, 1.0 parts by mass of carboxymethyl cellulose as a thickener, and an appropriate amount of water were stirred with a twin-arm kneader. The negative electrode mixture paste was applied to both surfaces of a negative electrode current collector made of a copper foil except for a negative electrode lead-connected portion, and dried to form a negative electrode mixture layer. The prepared negative electrode precursor was compressed to obtain a negative electrode. The negative electrode lead-connected portion was formed at a winding-finish end of the negative electrode.

### (Production of Electrode Assembly)

The positive and negative electrodes produced as described above and a microporous membrane separator made of an olefin-based resin were wound with a winding machine using a winding core of Φ4, an insulating anti-winding tape was attached to a winding-finish portion, and then the wound positive and negative electrodes and separator was removed from the winding core to produce a wound electrode assembly.

### (Production of Non-Aqueous Electrolyte)

A non-aqueous electrolyte was prepared by dissolving LiPF₆ as an electrolyte salt at a concentration of 1.0 M (mol/liter) in a non-aqueous solvent obtained by mixing ethylene carbonate and dimethyl carbonate in a volume ratio of 40:60 (1 atmosphere, 25° C. conversion).

### (Production of Cylindrical Battery)

The electrode assembly was inserted into an external can having a height of 74.5 mm and a diameter of 21 mm, and the diameter of the opening was reduced. Next, an upper insulating plate made of a phenol resin (GP) mixed with glass fibers and having an outer diameter of 20 mm and a thickness of 0.3 mm was inserted. Thereafter, a cylindrical battery was produced by welding the positive electrode lead to a vent member (a rupture disk) having an annular recess having a depth of 5% with respect to an outer diameter of the vent member and a height of 5% with respect to a thickness of the vent member (a maximum thickness of a portion sandwiched by a gasket in the vent member), injecting the non-aqueous electrolyte, and caulking the sealing assembly, the gasket (PP), and the opening-side end of the external can with a pressing machine. The cylindrical battery had a rated capacity of 5.0 Ah.

### Example 2

A cylindrical battery was produced, with a difference from the cylindrical battery of Example 1 only in that a vent member (a rupture disk) having an annular recess having a depth of 5% with respect to an outer diameter of the vent member and a height of 10% with respect to a thickness of the vent member (a maximum thickness of a portion sandwiched by a gasket in the vent member) was used. The cylindrical battery had a rated capacity of 5.0 Ah.

### Example 3

A cylindrical battery was produced, with a difference from the cylindrical battery of Example 1 only in that a vent member (a rupture disk) having an annular recess having a depth of 5% with respect to an outer diameter of the vent member and a height of 50% with respect to a thickness of the vent member (a maximum thickness of a portion sandwiched by a gasket in the vent member) was used. The cylindrical battery had a rated capacity of 5.0 Ah.

### Example 4

A cylindrical battery was produced, with a difference from the cylindrical battery of Example 1 only in that a vent member (a rupture disk) having an annular recess having a depth of 5% with respect to an outer diameter of the vent member and a height of 80% with respect to a thickness of the vent member (a maximum thickness of a portion sandwiched by a gasket in the vent member) was used. The cylindrical battery had a rated capacity of 5.0 Ah.

### Example 5

A cylindrical battery was produced, with a difference from the cylindrical battery of Example 1 only in that a vent member (a rupture disk) having an annular recess having a depth of 10% with respect to an outer diameter of the vent member and a height of 5% with respect to a thickness of the vent member (a maximum thickness of a portion sandwiched by a gasket in the vent member) was used. The cylindrical battery had a rated capacity of 5.0 Ah.

### Example 6

A cylindrical battery was produced, with a difference from the cylindrical battery of Example 1 only in that a vent member (a rupture disk) having an annular recess having a depth of 10% with respect to an outer diameter of the vent member and a height of 10% with respect to a thickness of the vent member (a maximum thickness of a portion sandwiched by a gasket in the vent member) was used. The cylindrical battery had a rated capacity of 5.0 Ah.

### Example 7

A cylindrical battery was produced, with a difference from the cylindrical battery of Example 1 only in that a vent member (a rupture disk) having an annular recess having a depth of 10% with respect to an outer diameter of the vent member and a height of 50% with respect to a thickness of the vent member (a maximum thickness of a portion sandwiched by a gasket in the vent member) was used. The cylindrical battery had a rated capacity of 5.0 Ah.

### Example 8

A cylindrical battery was produced, with a difference from the cylindrical battery of Example 1 only in that a vent member (a rupture disk) having an annular recess having a depth of 10% with respect to an outer diameter of the vent member and a height of 80% with respect to a thickness of the vent member (a maximum thickness of a portion sandwiched by a gasket in the vent member) was used. The cylindrical battery had a rated capacity of 5.0 Ah.

### Example 9

A cylindrical battery was produced, with a difference from the cylindrical battery of Example 1 only in that a vent member (a rupture disk) having an annular recess having a depth of 12% with respect to an outer diameter of the vent member and a height of 5% with respect to a thickness of the vent member (a maximum thickness of a portion sandwiched by a gasket in the vent member) was used. The cylindrical battery had a rated capacity of 5.0 Ah.

### Comparative Example

A cylindrical battery was produced, with a difference from the cylindrical battery of Example 1 only in that a vent member (a rupture disk) having no annular recess was used. The cylindrical battery had a rated capacity of 5.0 Ah.

### (Temperature Cycle Test)

For each of the cylindrical batteries of Examples 1 to 9 and the cylindrical battery of Comparative Example, a temperature cycle test was performed with five samples each having a state of charge (SOC) of 30%. Specifically, a cycle of maintaining a temperature of 85±2° C. for 6 hours and then maintaining a temperature of −40±2° C. for 6 hours was repeated 10 times, and then a temperature of 20° C. was maintained for 24 hours. After the test, it was checked whether a liquid leakage occurred at the caulked portion of the cylindrical battery, and whether the mass of the cylindrical battery changed.

### (Flat Plate Crushing Condition)

For each of the cylindrical batteries of Examples 1 to 9 and the cylindrical battery of Comparative Example, a flat plate crushing test was performed with five samples. Specifically, crushing at the time of 25% deformation was inspected. The crushing speed was 15 mm/sec, and the test temperature was 25° C. After the test, it was checked whether the cylindrical battery had a sign for a short circuit caused by the breakage of the gasket.

### [Test Results]

TABLE 1

| | | | Temperature cycle | |
|---|---|---|---|---|
| | Recess | Recess | test (liquid leakage | 25% crushing test |
| | depth | height | test) | (short circuit test) |
| Comparative | 0% | 0% | Present (5/5) | Present (3/5) |
| example | | | | |
| Example 1 | 5% | 5% | Absent (0/5) | Present (2/5) |
| Example 2 | 5% | 10% | Absent (0/5) | Absent (0/5) |
| Example 3 | 5% | 50% | Absent (0/5) | Absent (0/5) |
| Example 4 | 5% | 80% | Absent (0/5) | Absent (0/5) |
| Example 5 | 10% | 5% | Absent (0/5) | Present (2/5) |
| Example 6 | 10% | 10% | Absent (0/5) | Absent (0/5) |
| Example 7 | 10% | 50% | Absent (0/5) | Absent (0/5) |
| Example 8 | 10% | 80% | Absent (0/5) | Absent (0/5) |
| Example 9 | 12% | 5% | Absent (0/5) | Absent (0/5) |

In the liquid leakage test for the cylindrical battery of Comparative Example, a liquid leakage from between the vent member and the gasket occurred in all the samples. On the other hand, in the liquid leakage test for each of the cylindrical batteries of Examples 1 to 9, a liquid leakage from between the vent member and the gasket did not occur in all the samples. This is because in each of the cylindrical batteries of Examples 1 to 9, the vent member has a recess (an annular recess in the examples) on an outer circumferential surface thereof, and the gasket has a protrusion (an annular protrusion in the examples) fitted into the annular recess. Therefore, it is presumed that this is because the contact area between the vent member and the gasket can be increased and the route along which the electrolytic solution crawls up can be complicated (labyrinth), and as a result, a liquid leakage from between the vent member and the gasket can be suppressed.

In the short circuit test, a short circuit was confirmed in three of the five samples for the cylindrical battery of Comparative Example, while no short circuit was confirmed in all the samples for each of the cylindrical batteries of Examples 2-4 and 6-9. In addition, the number of samples in which a short circuit was confirmed for each of the cylindrical batteries of Examples 1 and 5, where a short circuit was confirmed, was smaller than the number of samples in which a short circuit was confirmed for the cylindrical battery of Comparative Example. It is presumed that this is because, in each of the cylindrical batteries of Examples 1 to 9, since the gasket has a protrusion fitted into the recess of the vent member, the gasket can be thickened, and as a result, the breakage of the gasket can be suppressed if the battery is physically deformed when an external force is applied thereto. From the above test results, even if an excessive external force is applied to a cylindrical battery produced according to the present disclosure, it is possible to suppress a short circuit between the positive and negative electrodes, and it is also possible to suppress a liquid leakage caused when the electrolytic solution crawls up, thereby realizing a cylindrical battery having high battery reliability in long-term storage.

The present disclosure is not limited to the above-described embodiment and the modifications thereof, and various improvements and changes can be made within the scope set forth in the claims of the present application and the equivalents thereof. For example, in the embodiment described above, the case where the vent member 27 has an annular recess 52 on the outer circumferential surface thereof, and the gasket 28 has an annular protrusion 53 fitted into the annular recess 52 has been described. However, the sealing assembly may have one recess that is not annular on the outer circumferential surface thereof, and the gasket may have one protrusion fitted into the one recess. Alternatively, the sealing assembly may have a plurality of recesses positioned at intervals in the circumferential direction on the outer circumferential surface thereof, and the gasket may have a plurality of protrusions fitted into the plurality of recesses and positioned at intervals in the circumferential direction. In this case, the plurality of recesses and the plurality of protrusions are preferably arranged at equal intervals in the circumferential direction.

Further, the case where the recess provided on the outer circumferential surface of the sealing assembly 17 is provided only in the vent member (the rupture plate) has been described. However, the outer circumferential surface of the sealing assembly may be configured in a laminated structure including a plurality of members. For example, the outer circumferential surface of the sealing assembly may be configured as an outer circumferential surface in a laminated structure including a terminal cap, an upper vent member, a lower vent member, and a terminal plate. Then, a recess may be provided on the outer circumferential surface of the laminated structure. In addition, in the cylindrical battery according to the present disclosure, the member constituting the positive electrode in the sealing assembly may be a terminal cap, and the member constituting the positive electrode may have a protrusion protruding outward in the axial direction at a central portion in the radial direction.

### REFERENCE SIGNS LIST

10, 110, 210, 310 Cylindrical battery
11 Positive electrode
12 Negative electrode
13 Separator
14 Electrode assembly
15 Battery case
16, 116 External can
17 Sealing assembly
18 Upper insulating plate
19 Lower insulating plate
20 Positive electrode lead
21 Negative electrode lead
23 Terminal plate
23a Central portion
23b Ventilation hole
25 Insulating plate
25a Through hole
25b Ventilation hole
25c Skirt
27, 127, 227, 327 Vent member
27a Central portion
27b Outer circumferential portion
27c Thin portion
27d Protrusion
28, 128, 228, 328 Gasket
30 Bottomed cylindrical portion
31 Peripheral edge
32 Sandwiched portion
33 Shoulder portion
52, 152, 252, 352 Annular recess
53, 153, 253, 353 Annular protrusion
68 Bottom plate portion
133 Shoulder portion

1. A cylindrical battery comprising:
an electrode assembly in which a positive electrode and a negative electrode are wound with a separator interposed therebetween;
a bottomed cylindrical external can that houses the electrode assembly;
a sealing assembly that seals an opening of the external can; and
a gasket that insulates the external can and the sealing assembly from each other,
wherein the sealing assembly has at least one recess that is open outward in a radial direction on an outer circumferential surface thereof, and
the gasket has at least one protrusion protruding inward in the radial direction and fitted into the at least one recess.

2. The cylindrical battery according to claim 1, wherein the at least one recess is one annular recess and the at least one protrusion is one annular protrusion.

3. The cylindrical battery according to claim 1, wherein a depth of the recess is smaller than or equal to 10% of an outer diameter of the sealing assembly.

4. The cylindrical battery according to claim 1, wherein a maximum height of the recess in an axial direction is greater than or equal to 10% of a maximum thickness in a sandwiched portion of the sealing assembly that is sandwiched in the axial direction by the gasket.

5. The cylindrical battery according to claim 1, wherein a depth of the recess is greater than or equal to 2% of an outer diameter of the sealing assembly.

6. The cylindrical battery according to claim 1, wherein a maximum height of the recess in an axial direction is smaller than or equal to 20% of a maximum thickness in a sandwiched portion of the sealing assembly that is sandwiched in the axial direction by the gasket.
